(19) United States
(12) Patent Application Publication
(10) Pub. No.: US 2017/0080535 A1
(43) Pub. Date: Mar. 23, 2017

(54) SCREW DRIVING APPARATUS AND SCREW FEEDING ASSEMBLY THEREOF

(71) Applicants: HONGFUJIN PRECISION ELECTRONICS (CHENGDU) Co., Ltd ., Chengdu (CN); HON HAI PRECISION INDUSTRY CO., LTD., New Taipei (TW)

(72) Inventor: CHAO LI, Shenzhen (CN)

(21) Appl. No.: 15/075,403

(22) Filed: Mar. 21, 2016

(30) Foreign Application Priority Data
Sep. 21, 2015 (CN) 201510602167.X

(51) Int. Cl. B23P 19/00; B23P 19/06

(52) U.S. Cl. CPC B23P 19/004; B23P 19/06; B23P 19/006

(57) ABSTRACT

A screw driving apparatus includes a screw feeding assembly and a screw fastening assembly configured to fastening the screw into a workpiece. The screw feeding assembly includes a feeding member, a moving member, and an unloading member. The feeding member includes a first slide path, a second slide path, and a connecting groove. The first slide path and the second slide path intersect with the connecting groove at different positions. At least a part of the moving member is movably received in the connecting groove. The unloading member defines an unloading hole in communication with the second slide path. The moving member is capable of moving between a first position and a second position in the connecting groove. A screw fastening assembly of the screw driving apparatus is also provided.

### FIELD

The subject matter herein generally relates to a screw driving apparatus and a screw feeding assembly of the screw driving apparatus.

### BACKGROUND

Screw driving apparatus are used to driving a screw into a workpiece. A conventional screw driving apparatus includes a screw feeding assembly and a fastening assembly. In operation, the screws can be separated by the screw feeding assembly, and then screwed into the workpiece by the screw fastening assembly. The screws can drop into a unloading hole by gravity in the screw feeding assembly.

### BRIEF DESCRIPTION OF THE DRAWINGS

Implementations of the present technology will now be described, by way of example only, with reference to the attached figures.

FIG. 1 is an isometric view of one embodiment of a screw driving apparatus.

FIG. 2 is a partial, exploded view of the screw driving apparatus shown in FIG. 1.

FIG. 3 is similar to FIG. 2, but viewed from another angle.

FIG. 4 is an isometric view of a screw feeding assembly of the screw driving apparatus shown in FIG. 1.

FIG. 5 is an enlarged view of a portion V of the screw feeding assembly shown in FIG. 4.

FIG. 6 is an exploded, isometric view of the screw feeding assembly shown in FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series and the like.

The present disclosure is described in relation to a screw driving apparatus and a screw feeding assembly thereof.

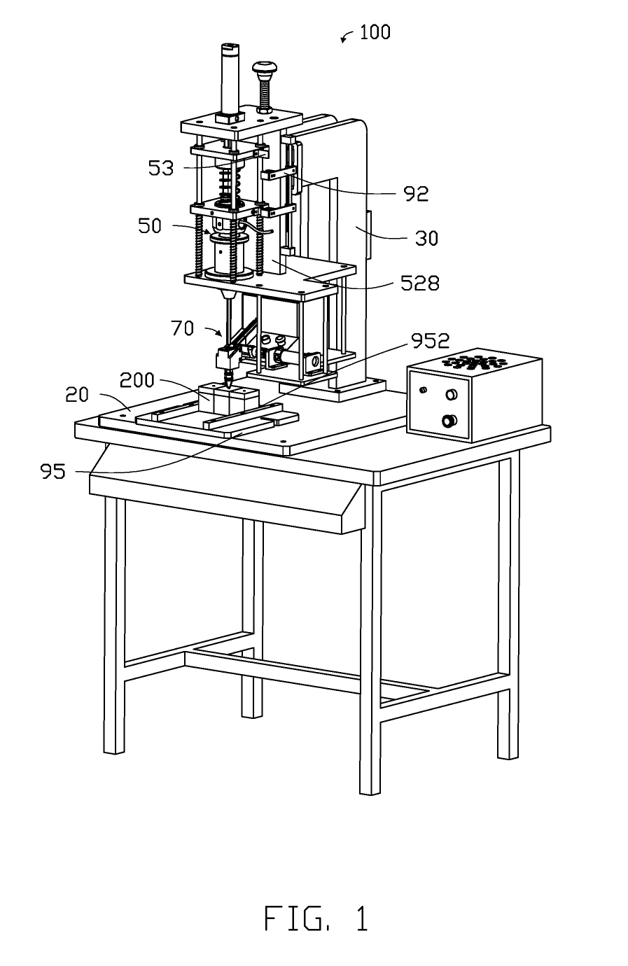

FIG. 1 illustrates that a screw driving apparatus 100 includes a table 20, a bracket 30 mounted on the table 20, a screw fastening assembly 50, and a screw feeding assembly 70. A workpiece 200 can be placed on the table 20. The screw feeding assembly 70 can be positioned between the screw fastening assembly 50 and the table 20 and be configured to provide a signal screw (not shown) to the screw fastening assembly 50. The screw fastening assembly 50 can move toward the screw fastening assembly 70 and the table 20, thereby mounting the screw to the workpiece 200.

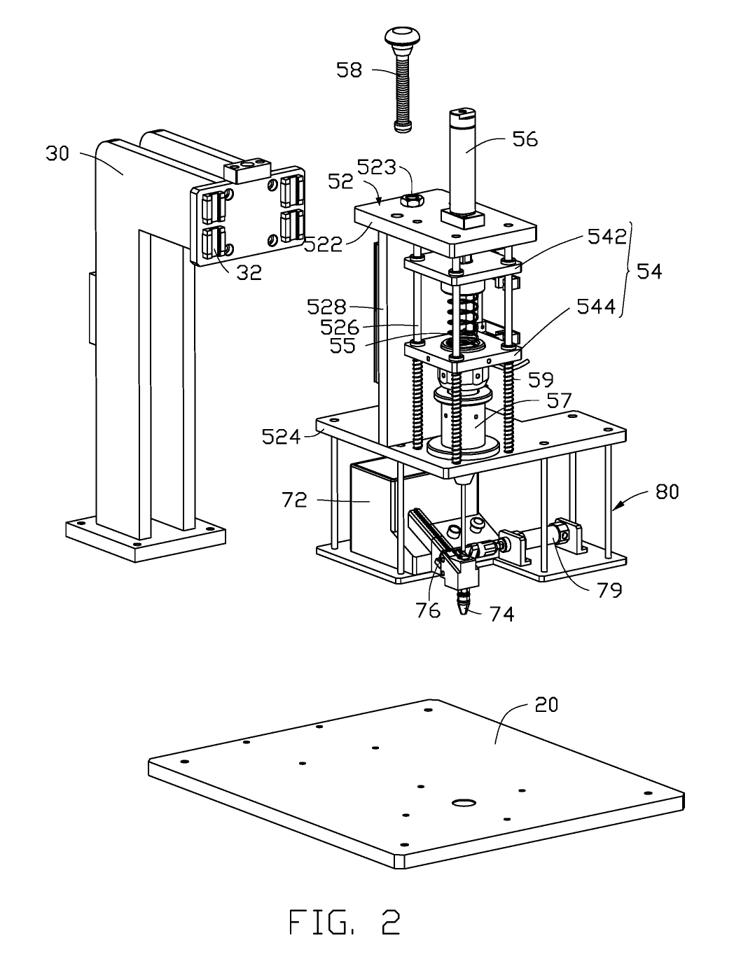

FIG. 2 illustrates that the bracket 30 can includes a guide groove 32. The screw fastening assembly 50 can include a frame 52, a sliding plate 54, a driving member 56, a screw driver 57, and at least one elastic member 59. The frame 52 can include a first fixing plate 522 and a second fixing plate 524 facing each other, and at least one guiding post 526 perpendicularly passing through the first fixing plate 522 and the second fixing plate 524. The at least one elastic member 59 can be coiled on the corresponding guiding post 526 and located between the sliding plate 54 and the second fixing plate 524. In at least one embodiment, there are four guiding posts 526, and the four guiding posts 526 can be spaced from each other. The sliding plate 54 can be sleeved on the four guiding posts 526. The driving member 56 can be mounted on the first fixing plate 522 and coupled to the sliding plate 54. In at least one embodiment, the driving member 56 can be cylinder. The screw driver 57 can be fixed on the sliding plate 54 and movably pass through the second fixing plate 524. In at least one embodiment, the screw driver 57 can be an autofeed screwdriver. There are four elastic members 59, and each of the elastic members 59 can be sleeved on the corresponding guiding post 526. When the driving member 56 drives the sliding plate 54 to move, the screw driver 57 can move with the sliding plate 54 to tighten the screw, and the elastic members 59 can be compressed. The elastic members 59 can provide elastic force to the sliding plate 54 to decrease the impact force to the workpiece 200.

In at least one embodiment, the sliding plate 54 can include a first sliding plate 542 and a second sliding plate 544. The guiding posts 526 can penetrate the first sliding plate 542 and the second sliding plate 544. The first sliding plate 542 can be coupled to the driving member 56, and the second sliding plate 544 can be coupled to the screwdriver 57. The elastic member 59 can be positioned between the second sliding plate 544 and the second fixing plate 524. A buffer member 55 can be positioned between the first sliding plate 542 and the second sliding plate 544. The buffer member 55 can be an elastic member having a high elasticity. When the first sliding plate 542 moves toward the workpiece 200, the first sliding plate 542 and the second sliding plate 544 would not move relative to each other. When the screwdriver 57 tightens the screw on the workpiece 200, the buffer member 55 can be compressed, thus the impact on the workpiece 200 and the screw fastening assembly 50 can be decreased.

The frame 52 can further include a connecting plate 528 positioned between the first fixing plate 522 and the second fixing plate 524. The connecting plate 528 can be distanced from the guiding posts 526. The screw driving apparatus 100 can further include an adjusting screw bolt 58 coupled to the first fixing plate 522. The first fixing late 522 can define a screw hole 523 coupled to the adjusting screw bolt 58.

The screw feeding assembly 70 can be coupled to the frame 52 via a fixing frame 80, thus the screw feeding assembly 70 can move with the screw fastening assembly 50. The screw feeding assembly 70 can include a feeding member 72, an unloading member 74, a moving member 76, and a cylinder 79 mounted on the fixing frame 80. The moving member 76 can be movably mounted between the feeding member 72 and the unloading member 74. The feeding member 72 can be configured to feed the screws to the unloading member 74. The moving member 76 can move between a first position to a second position, thereby transferring the screw in the feeding member 72 to the unloading member 74. The unloading member 74 can be coupled to the feeding member 72 and positioned below the screwdriver 57.

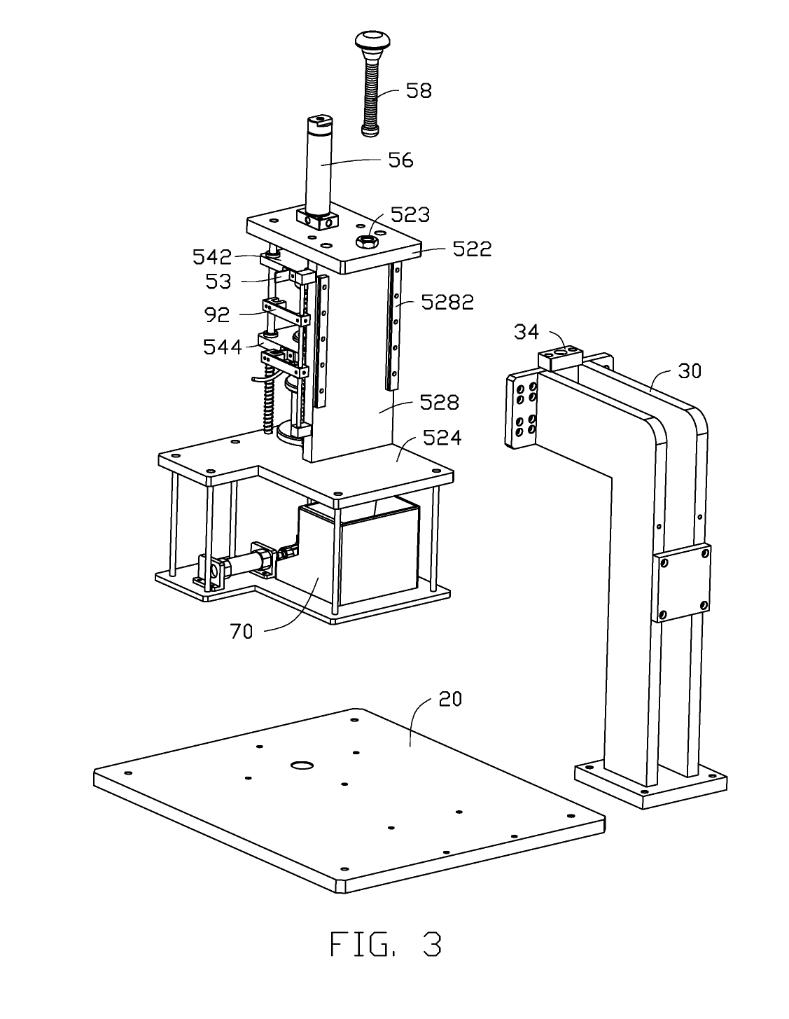

FIG. 3 illustrates that the bracket 30 can include a fixing block 34. The adjusting screw bolt 58 can pass through the screw hole 523 and coupled to the fixing block 34. The connecting plate 528 can include a guiding rail 5282 extending along the lengthwise direction of the connecting plate 528. The connecting plate 528 can be movably coupled to the guide groove 32 (shown in FIG. 2), so the guiding rail 5282 can be movably coupled to the frame 52, and the screw fastening assembly 50 can be slidably mounted on the frame 30. When the adjusting screw bolt 58 rotates, the screw fastening assembly 50 can move along the frame 30.

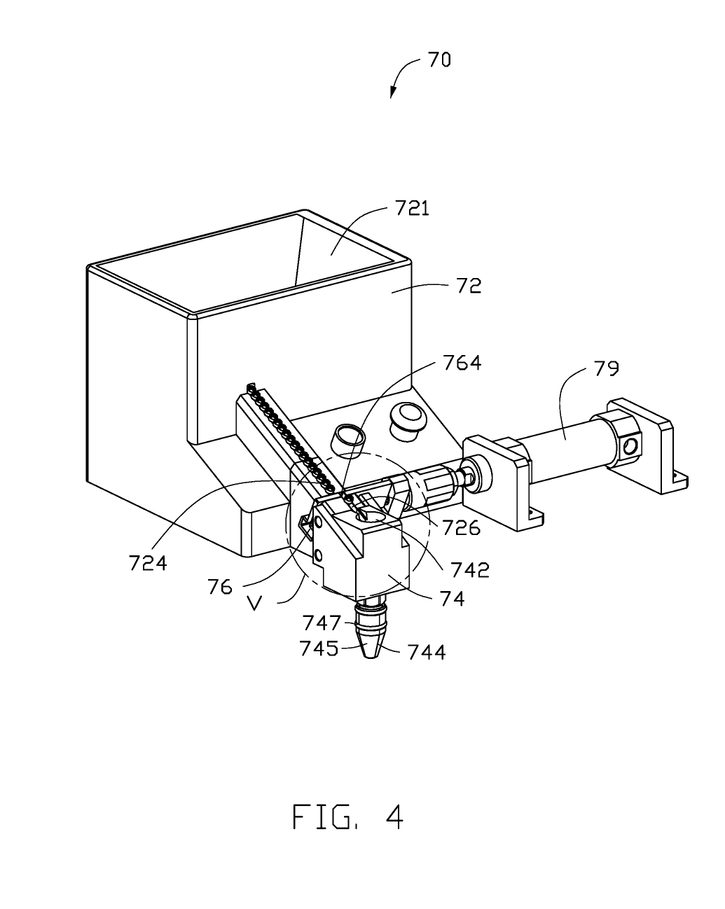

FIG. 4 illustrates that the feeding member 72 can include a receiving groove 721 configured to accommodate the screws. The unloading member 74 can define an unloading hole 742, and a free end of the unloading member 74 can include a clamping portion 744. The clamping portion 744 can include four clamping jaws 745 surrounding the free end of the unloading member 74. The free end is one end of the unloading member 74 away from the feeding member 72. The four unloading member 74 can further include an elastic ring 747 on outer walls of the four clamping jaws 745. The clamping jaws 745 can be mounted on the unloading member 74 by the elastic ring 747, thus the clamping jaws 745 can restore elasticity. The number of the clamping jaws 745 can be two, three, or more than four.

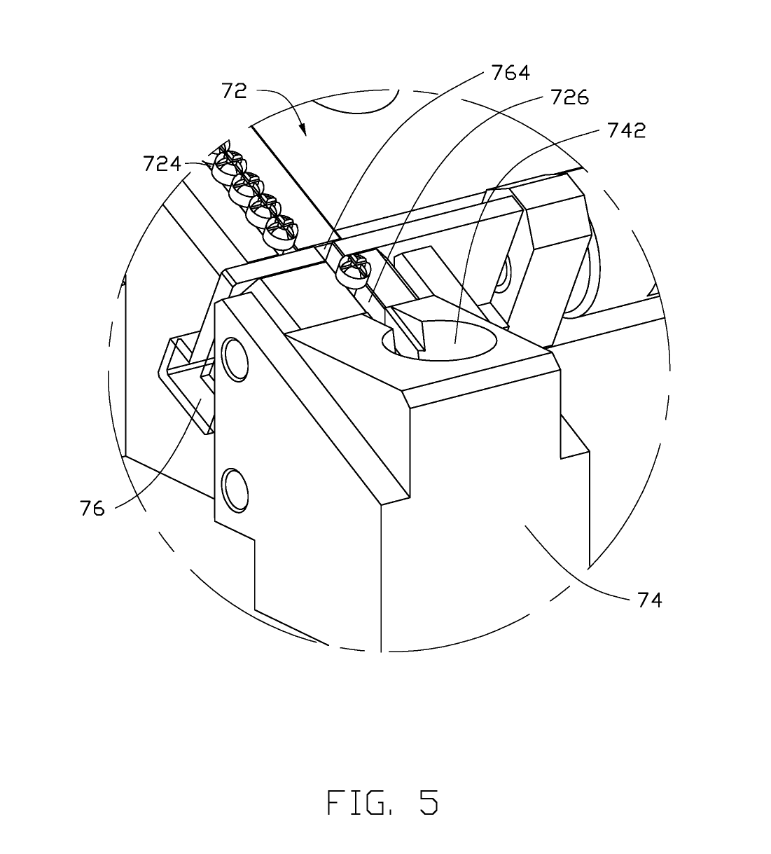

FIG. 5 illustrates that the feeding member 72 can further include a connecting groove 722, a first slide path 724, and a second slide path 726. The first slide path 724 and the second slide path 726 can intersect with the connecting groove 722 at different positions, thereby the first slide path 724 and the second slide path 726 can be staggered. The connecting groove 722 can be defined between the first slide path 724 and the second slide path 726. The first slide path 724 can be in communication with the receiving groove 721 and the connecting groove 722. The first slide path 724 can slope downward from the receiving groove 721. The second slide path 726 can be in communication with the connecting groove 722 and the unloading hole 742, and the second slide path 726 can slope downward from the connecting groove 722. The first slide path 724 and the second slide path 726 can enable only one screw to pass through at a time. At least a part of the moving member 76 can be movably received in the connecting groove 722. In at least one embodiment, a cross-section of the connecting groove 722 can be T-shaped.

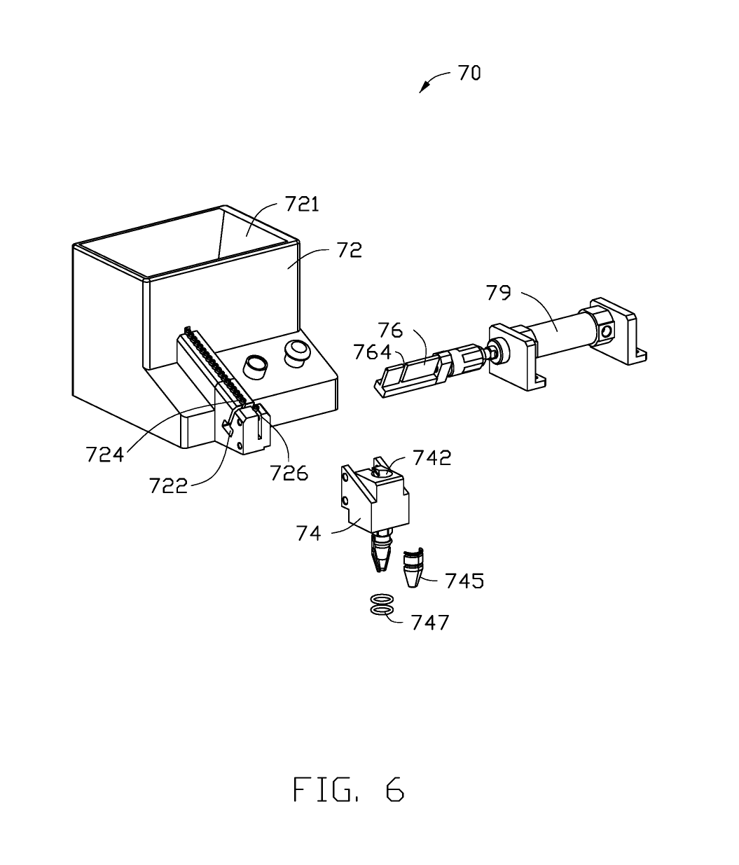

FIG. 6 illustrates that the moving member 76 can define a notch 764, and a width of the notch 764 is slightly larger than a width of the screw, thereby only one screw can pass through the notch 764 at a time. A cross-section of the moving member 76 and a cross-section of the notch 764 can be T-shaped. The moving member 76 can be coupled to the cylinder 79, and the cylinder 79 can be configured to drive the moving member 76 to move along the connecting groove 722, thereby the moving member can move between the first position to the second position. When the moving member 76 is located at the first position, the notch 764 can be in communication with the first slide path 724, and the second slide path 726 can be sealed by the moving member 76. At this time, one screw can drop into the notch 764 along the first slide path 724 by gravity. When the moving member is located at the second position, the notch 764 can be in communication with the second slide path 726, and the first slide path 724 can be sealed by the moving member 76. At this time, the screw in the notch 764 can drop into the unloading member 74 along the second slide path 726 by gravity.

The four clamping jaws 745 can tightly clamp the screw. When the screw driver 57 stretched into the unloading hole 742 driven by the driving member 56, the screw driver 57 can push the screw clamped by the four clamping jaws 745, and then the four clamping jaws 745 can release the screw.

FIG. 1 illustrates that the screw driving apparatus 100 can further include two first sensors 92 mounted on the connecting plate 528 and distanced from each other. The first sliding plate 542 and the second sliding plate 544 can include two sensing portions 53 corresponding to the two first sensors 92. When the sensing portions 53 of first sliding plate 542 and the second sliding plate 544 move to positions corresponding to the two first sensors 92, the first sensors 92 can transmit signals to the screw driver 57, and the screw driver 57 can rotate to tighten the screw. In other embodiments, the first sensor 92 can be one, and the sensing portion 53 can be one and mounted on the first sliding plate 542 or the second sliding plate 544. A number of the first sensors 92 can be more than two.

A positioning fixture 95 that includes a positioning portion 952 can be mounted on the table 20 for holding the workpiece 200. When a sidewall of the workpiece 200 abuts the positioning portion 952, a screwed hole (not shown) of the workpiece 200 can be aligned with the screwdriver 57. The positioning portion 952 can include a second sensor (not shown). When the sidewall of the workpiece 200 abuts the positioning portion 952, the second sensor can transmit a signal to the driving member 56, and then the driving member 56 can drive the screwdriver 57 to move toward the workpiece 200.

In assembling the screw driving apparatus 100, the bracket 30 can be mounted on the table 20, the frame 52 can be slidably mounted on the bracket 30, and the adjusting screw bolt 58 can penetrate through the first fixing plate 522 and coupled to the bracket 30. Then, the first sliding plate 542 and the second sliding plate 544 can be slidably sleeved on the guiding posts 526, and the buffer member 55 can be positioned between the first sliding plate 542 and the second sliding plate 544. The driving member 56 can be mounted on the first mounting plate 522 and coupled to the first sliding plate 542, and the screw driver 57 can be coupled to the second sliding plate 544. One end of the screw driver 57 can be movably pass through the second fixing plate 524. After that, the fixing frame 80 can be coupled to the frame 52, and the fixing frame 80 can be positioned between the screw fastening assembly 50 and the table 20. The feeding member 72 can be mounted on the fixing frame 80, and the unloading member 74 can be coupled to the feeding member 72 and positioned below the screw driver 57. The moving member 76 can be slidably inserted into the connecting groove 722, and the cylinder 79 can be mounted on the fixing frame 80 and coupled to the moving member 76.

In operation, the workpiece 200 can be placed on the positioning fixture 95. For example, two workpieces 200 can be placed on the positioning fixture 95 and stacked together. The screw holes of the two workpieces 200 can be aligned to the unloading hole 742. The second sensor can transmit a signal to the driving member 56, and the driving member 56 can drive the sliding plate 54 move along the guiding posts 526. The screw driver 57 can move toward the unloading hole 742, and the elastic member 59 can be compressed. When the sensing portion 53 moves to a sensing area of the first sensor 92, the first sensing 92 can transmit the signal the screw driver 57, and the screw driver 57 can be rotated.

The cylinder 89 can drive the moving member 76 to the first position. One screw can drop into the notch 764 from the receiving groove 721 along the first slide path 724. Then, the cylinder 89 can drive the moving member 76 to the second position. At this time, the first slide path is sealed by the moving member 76, and the notch 764 can be in communication with the second slide path. The screw in the notch 764 can drop into unloading hole 742 along the second slide path 726 by gravity. Then, the screw can be clamped by the clamping portion 744.

The screw driver 57 can continue to move toward the unloading hole 742 driven by the driving member 56, thereby the screw driver 57 can push against the clamping portion 744, the clamping portion 744 can be opened to release the screw. The screw driver 57 can be rotated to tighten the screw on the two workpieces 200. When assembling the screw, the buffer member 55 can be compressed. After the screw is assembled, the buffer member 55 and the elastic member 59 can be restored from elastic deformation to drive the screw driver 57 to move to the initial position.

The screw driving apparatus 100 can include the screw feeding assembly 70, and the screw feeding assembly 70 can include the first slide path 724, the second slide path 726, the connecting groove 722, and the moving member 76. The screw can drop into the notch 746 when the moving member 76 is located at the first position, and the screw can drop into the second slide path 726 when the moving member 76 is located at the second position. Therefore, the moving member 76 can transfer the screw from the first slide path 724 to the second slide path 726, and only one or a predetermined number of screws can be separated and provided to the screw fastening assembly 50. Thus, assembly time can be shortened. The adjusting screw bolt 58 can be rotated to drive the screw fastening assembly 50 and the screw separating assembly 70 to move along the bracket 30, thereby a distance between the workpiece 200 and the unloading hole 74 can be adjusted. Therefore, the screw driving apparatus 100 can be adapted to workpieces having different sizes. The clamping jaws 745 mounted on the free end of the unloading member 74 can release the screw gradually, so the screw would not be inclined to the workpiece during assembling. The screw can be coaxial with the workpiece, and the assembling accuracy is high. Morever, the buffer member 55 and the elastic member 59 can decrease the impact on the workpiece. The screw driver 57 and the driving member 56 can be controlled by the first sensor 92 and the second sensor, thereby the screw can be automatically assembled, reducing manpower and cost.

In other embodiments, the notch 764 can be omitted. When the moving member 76 is located at the first position, the screw can drop into the connecting groove 764 from the first slide path 724 and stayed in the connecting groove 764. When the moving member 76 moves toward the second position, the moving member 76 can be pushed by the moving member 76 and drop into the second slide path 726 and the unloading 742.

In other embodiments, the fixing frame 80 and be omitted, and the screw separating assembly 70 can be mounted on the bracket 30 or the table 20. In other embodiments, the frame 52 can be omitted, and the screw fastening assembly 50 can be mounted on the bracket 30.

The embodiments shown and described above are only examples. Many details are often found in the art such as the other features of a screw driving apparatus and a screw separating assembly thereof. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A screw driving apparatus configured to driving screws into a workpiece, the screw driving apparatus comprising:
a screw fastening assembly configured to fastening the screw into the workpiece; and
a screw feeding assembly comprising:
a feeding member comprising a first slide path, a second slide path, and a connecting groove positioned between the first slide path and the second slide path, the first slide path and the second slide path intersecting with the connecting groove at different positions;
a moving member capable of moving between a first position and a second position in the connecting groove, wherein at least a part of the moving member is movably received in the connecting groove; and
an unloading member defining an unloading hole in communication with the second slide path;
wherein one end of the second slide path adjacent to the connecting hole is sealed by the moving member when the moving member is located at the first position, and one end of the first slide path adjacent to the connecting hole is sealed by the moving member when the moving member is located at the second position; and
wherein the feeding member is capable of providing a screw to the connecting groove through the first slide path when the moving member is located at the first position, and the moving member is capable of pushing the screw in the connecting groove to the second slide path when moving to the second position, thereby the screw drops into the unloading hole through the second slide path and assembled by the screw fastening assembly.

2. The screw driving apparatus as claimed in claim 1, wherein the moving member comprises a notch, the notch is in communication with the first slide path when the moving member is located at the second position, and the notch is in communication with the second slide path when the moving member is located at the first position.

3. The screw driving apparatus as claimed in claim 2, wherein the feeding member further comprises a receiving groove configured for accommodating the screws, and the first slide path is in communication with the receiving groove.

4. The screw driving apparatus as claimed in claim 3, wherein the first slide path slops downward toward the connecting groove, the second slide groove slops downward toward the unloading member, and each of the first slide path, the second slide path, and the connecting groove has a width enable one of the screws to pass through at a time.

5. The screw driving apparatus as claimed in claim 1, wherein the unloading member comprises a clamping portion configured to clamp the screw, and the clamping portion comprises at least two clamping jaws surrounding one end of the unloading member away from the feeding member.

6. The screw driving apparatus as claimed in claim 5, wherein the clamping portion further comprises an elastic ring sleeved on the at least two clamping jaws.

7. The screw driving apparatus as claimed in claim 1, wherein the screw feeding assembly further comprises a cylinder coupled to the moving plate and configured to drive the moving plate to move in the connecting groove.

8. The screw driving apparatus as claimed in claim 1,
wherein the screw fastening assembly comprises a frame, a sliding plate, a driving member, and a screw driver, and the frame comprises a first fixing plate and a second fixing plate facing each other, and a guiding post positioned between the first fixing plate and the second fixing plate; and
wherein the sliding plate is slidably sleeved on the guiding post, the driving member is mounted on the first fixing plate and coupled to the sliding plate; the screw driver is mounted on the sliding plate and slidably penetrates the second fixing plate, and the driving member is configured to drive the screw driver to stretch into the unloading groove.

9. The screw driving apparatus as claimed in claim 8, wherein the screw fastening assembly further comprises an elastic member sleeved on the guiding post and positioned between the sliding plate and the second fixing plate.

10. The screw driving apparatus as claimed in claim 8,
wherein the sliding plate comprises a first sliding plate and a second sliding plate slidably sleeved on the guiding post, the first sliding plate is coupled to the driving member, and the second sliding plate is coupled to the screw driver; and
wherein the elastic member is positioned between the second sliding plate and the second fixing plate, and the crew fastening assembly further comprises a buffer member positioned between the first sliding plate and the second sliding plate.

11. The screw driving apparatus as claimed in claim 8,
wherein the screw driving apparatus further comprises a bracket, the frame of the screw fastening assembly is slidably mounted on the bracket, and the screw feeding member is coupled to the frame of the screw fastening assembly; and
wherein the screw driving apparatus further comprises an adjusting screw bolt, the adjusting screw bolt passes through the first fixing plate and coupled to the bracket, and the screw adjusting bolt drives the screw fastening assembly and the screw feeding assembly to move along the bracket when the screw adjusting bolt rotates.

12. A screw feeding assembly configured for feeding screws, the screw feeding assembly comprising:
a feeding member comprising a first slide path, a second slide path, and a connecting groove positioned between the first slide path and the second slide path, the first slide path and the second slide path intersecting with the connecting groove at different positions;
a moving member capable of moving between a first position and a second position in the connecting groove, wherein at least a part of the moving member is movably received in the connecting groove; and
an unloading member defining an unloading hole in communication with the second slide path;
wherein the moving member is capable of moving between a first position and a second position in the connecting groove, one end of the second slide path adjacent to the connecting hole is sealed by the moving member when the moving member is located at the first position, and one end of the first slide path adjacent to the connecting hole is sealed by the moving member when the moving member is located at the second position; and
wherein the feeding member is capable of providing a screw to the connecting groove through the first slide path when the moving member is located at the first position, and the moving member is capable of pushing the screw in the connecting groove to the second slide path when moving to the second position.

13. The screw feeding assembly as claimed in claim 12, wherein the moving member comprises a notch, the notch is in communication with the first slide path when the moving member is located at the second position, and the notch is in communication with the second slide path when the moving member is located at the first position.

14. The screw feeding assembly as claimed in claim 13, wherein the feeding member further comprises a receiving groove configured for accommodating the screws, and the first slide path is in communication with the receiving groove.

15. The screw feeding assembly as claimed in claim 14, wherein the first slide path slops downward toward the connecting groove, the second slide groove slops downward toward the unloading member, and each of the first slide path, the second slide path, and the connecting groove has a width enable one of the screws to pass through at a time.

16. The screw feeding assembly as claimed in claim 12, wherein the unloading member comprises a clamping portion configured to clamp the screw, and the clamping portion comprises at least two clamping jaws surrounding one end of the unloading member away from the feeding member.

17. The screw feeding assembly as claimed in claim 16, wherein the clamping portion further comprises an elastic ring sleeved on the at least two clamping jaws.

18. The screw feeding assembly as claimed in claim 12, wherein the screw feeding assembly further comprises a cylinder coupled to the moving plate and configured to drive the moving plate to move in the connecting groove.
